(19) United States
(12) Patent Application Publication
(10) Pub. No.: US 2020/0365026 A1
(43) Pub. Date: Nov. 19, 2020

(54) PARKING LOT MANAGEMENT APPARATUS, PARKING LOT MANAGEMENT METHOD, AND STORAGE MEDIUM

(71) Applicant: HONDA MOTOR CO., LTD., Tokyo (JP)

(72) Inventors: Junpei Noguchi, Wako-shi (JP); Chie Sugihara, Tokyo (JP); Yuta Takada, Tokyo (JP); Ryoma Taguchi, Tokyo (JP)

(21) Appl. No.: 16/869,612

(22) Filed: May 8, 2020

(30) Foreign Application Priority Data
May 16, 2019 (JP) 2019-092965

(51) Int. Cl. G08G 1/14; G06Q 10/02; G01C 21/34; G01C 21/36

(52) U.S. Cl. CPC G08G 1/141; G06Q 10/02; G06Q 2240/00; G01C 21/3679; G01C 21/3407

(57) ABSTRACT

A parking lot management apparatus according to an aspect of the present invention is a parking lot management apparatus including a processor a memory storing program instructions executable by the processor to receive designation of an exit reservation time at which a vehicle will exit a parking lot and confirm presence or absence of the designation of the exit reservation time for a vehicle intended to be parked in the parking lot, wherein receiving designation of the exit reservation time with respect to an unreserved vehicle for which to confirm that the exit reservation time has not been designated before a user alights from the vehicle to be parked in the parking lot.

### CROSS-REFERENCE TO RELATED APPLICATION

This application claims priority to and the benefit from Japanese Patent Application No. 2019-092965, filed on May 16, 2019, the contents of which are hereby incorporated by reference into the present application.

### BACKGROUND OF THE INVENTION

### Field of the Invention

The present invention relates to a parking lot management apparatus, a parking lot management method, and a storage medium.

### Description of Related Art

There is a technology of performing management of reservations in a parking lot in a parking lot in which vehicles can be parked (for example, Japanese Unexamined Patent Application, First Publication No. H9-16898, hereinafter Patent Document 1). This technology determines whether a parking lot can be reserved on the basis of a reservation status of the parking lot.

### SUMMARY

Recently, research on automatic control of vehicles has been conducted. However, in the aforementioned technology disclosed in Patent Document 1, improvement of convenience in a parking lot when the technology is applied to automatically controlled autonomous vehicles has not been taken into account.

An object of the present invention devised in view of such circumstances is to provide a parking lot management apparatus, a parking lot management method, and a storage medium which can improve convenience in a parking lot.

A parking lot management apparatus, a parking lot management method, and a storage medium according to the present invention employs the following configurations.

(1): A parking lot management apparatus according to an aspect of the present invention is a parking lot management apparatus including: a processor; and a memory storing program instructions executable by the processor to: receive designation of an exit reservation time at which a vehicle will exit a parking lot; and confirm presence or absence of the designation of the exit reservation time for a vehicle to be parked in the parking lot, wherein receiving the designation of the exit reservation time comprises receiving the designation of the exit reservation time with respect to an unreserved vehicle for which it is confirmed that the exit reservation time has not been designated before a user alights from the unreserved vehicle to be parked in the parking lot.

(2): In the aspect of (1), wherein receiving the designation of the exit reservation time comprises receiving the designation of the exit reservation time in a case where the unreserved vehicle is in congestion which occurs in front of an alighting place.

(3): In the aspect of (2), wherein receiving the designation of the exit reservation time comprises receiving the designation of the exit reservation time from an on-board input device provided in the vehicle or a terminal input device provided in a terminal device possessed by a user of the vehicle.

(4): In the aspect of (3), wherein the program instructions are further executable by the processor to: guide the vehicle to a target position, and in a case where the exit reservation time of the unreserved vehicle is reserved at an alighting place where a user alights, in front of which congestion does not occur, guiding the vehicle to the target position comprises starting guidance of the unreserved vehicle after receiving the designation of the exit reservation time from the on-board input device or the terminal input device.

(5): In the aspect of (4), wherein the program instructions are further executable by the processor to assign different usage conditions of the parking lot according to presence or absence of designation of the exit reservation time, and in a case where the designation of the exit reservation time of the unreserved vehicle is not received from the on-board input device or the terminal input device, assigning the usage conditions comprises causing the unreserved vehicle to be parked under usage conditions in a case where it is confirmed that there is no designation of the exit reservation time.

(6): In the aspect of (4), wherein the program instructions are further executable by the processor not to start the guidance of the unreserved vehicle in a case where the designation of the exit reservation time of the unreserved vehicle is not received from the on-board input device or the terminal input device.

(7): In the aspect of (3), wherein: the program instructions are further executable by the processor to give notification of information; and in a case where the unreserved vehicle in congestion is to be parked in the parking lot, giving the notification comprises giving notification of a request for designation of the exit reservation time to the on-board input device before giving the notification to the terminal input device.

(8): In the aspect of (7), wherein, in a case where the unreserved vehicle is to be parked in the parking lot in the alighting place where the user alights, in front of which congestion is not occurring, giving the notification comprises giving notification of a request for designation of the exit reservation time to the terminal input device after the user has alighted from the unreserved vehicle.

(9): In the aspect of (8), wherein, in a case where input of the exit reservation time from the user has been received before the user alights from the unreserved vehicle, the program instructions are further executable by the processor not to give the notification of the request for designation of the exit reservation time to the terminal input device and give the notification of information related to the receive exit reservation time to the terminal input device.

(10): In the aspect of (2), wherein: the program instructions are further executable by the processor to give notification of information; and in a case where it is confirmed that the exit reservation time has been designated and a reserved vehicle in the congestion is to be parked in the parking lot, giving the notification comprises giving notification of the confirmed exit reservation time to the reserved vehicle.

(11): In the aspect of (10), wherein; in a case where confirmation information transmitted from a user who has received the notification of the exit reservation time is acquired, giving the notification comprises giving notification of useful information useful for the user to the user.

(12): A parking lot management method according to an aspect of the present invention is a parking lot management method, using a computer, including: receiving designation of an exit reservation time at which a vehicle will exit a parking lot; and confirming presence or absence of designation of the exit reservation time for a vehicle intended to be parked in the parking lot, wherein receiving the designation of the exit reservation time comprises receiving the designation of the exit reservation time in a case where an unreserved vehicle for which it is confirmed that the exit reservation time has not been designated is in congestion which occurs in front of an alighting place where a user alights from a vehicle to be parked in the parking lot.

(13): A storage medium according to an aspect of the present invention is a computer-readable non-transitory storage medium storing a program causing a computer to: receive designation of an exit reservation time at which a vehicle will exit a parking lot; and confirm presence or absence of designation of the exit reservation time for a vehicle intended to be parked in the parking lot, wherein receiving the designation of the exit reservation time comprises receiving the designation of the exit reservation time in a case where an unreserved vehicle for which it is confirmed that the exit reservation time has not been designated is in congestion which occurs in front of an alighting place where a user alights from a vehicle to be parked in the parking lot.

According to (1) to (13), it is possible to improve convenience in a parking lot.

### BRIEF DESCRIPTION OF THE DRAWINGS

FIG. 1 is a diagram schematically showing a parking facility P including a parking lot management apparatus 400 according to an embodiment.

FIG. 2 is a configuration diagram of a vehicle system.

FIG. 3 is a functional configuration diagram of a first controller and a second controller.

FIG. 4 is a diagram showing an example of a functional configuration of a terminal device.

FIG. 5 is a diagram showing an example of a configuration of a parking lot management apparatus.

FIG. 6 is a flowchart showing an example of processing in the parking lot management apparatus.

FIG. 7 is a flowchart showing an example of processing in the parking lot management apparatus.

FIG. 8 is a flowchart showing an example of processing in the parking lot management apparatus.

FIG. 9 is a flowchart showing an example of processing in the parking lot management apparatus.

FIG. 10 is a diagram showing an example of a hardware configuration of a parking lot management apparatus according to an embodiment.

### DETAILED DESCRIPTION OF THE INVENTION

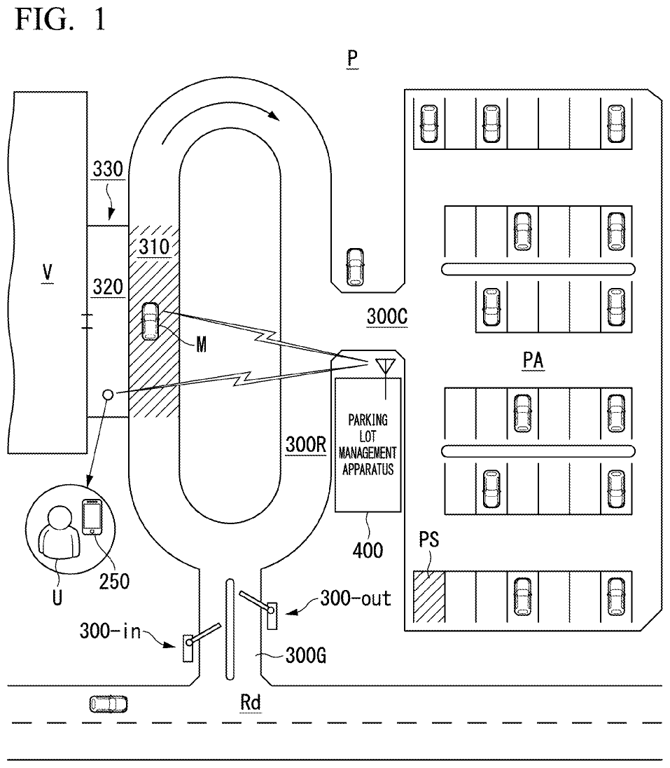

Hereinafter, embodiments of a parking lot management apparatus, a parking lot management method, and a storage medium of the present invention will be described with reference to the drawings. FIG. 1 is a diagram schematically showing a parking facility P including a parking lot management apparatus 400. The parking lot management apparatus 400 is installed in a part of the parking facility P, for example. The parking lot management apparatus 400 manages a vehicle which enters the parking facility PA and is parked in a parking lot PA. Specifically, the parking lot management apparatus 400 receives reservation of parking when a vehicle is parked in the parking lot PA and performs procedure guidance and vehicle guidance when a vehicle enters or exits the parking facility P.

The parking lot management apparatus 400 performs reservation of parking of an unreserved vehicle for which an exit reservation time is not designated on the basis of operations of an on-board parking management device 90 and a terminal device 250 mounted in the unreserved vehicle. A vehicle for which reservation of parking has been performed becomes a reserved vehicle. When reservation of parking is performed, the parking lot management apparatus 400 receives an entry reservation time and an exit reservation time of a vehicle. The parking lot management apparatus 400 records an entry time when a vehicle enters. When an exit reservation time is not received when a vehicle enters, the parking lot management apparatus 400 receives designation of the exit reservation time, for example, before a user alights from the vehicle after the vehicle has entered (after the vehicle has entered the parking facility P). The parking lot management apparatus 400 manages an exit time and guides the user to pay a charge for using the parking lot, for example, when the vehicle exits.

### [Overall Configuration]

As shown in FIG. 1, the parking lot management apparatus 400 is installed in a part of the parking facility P, for example, and manages an entry time, an exit reservation time, a parking position, and the like of a vehicle equipped with a vehicle system 1, which enters the parking facility P. The parking facility P is installed along side of a visit destination facility V by a road Rd, for example. The parking facility P includes a gate passage 300G, a round passage 300R, a connecting passage 300C, and the parking lot PA.

The gate passage 300G is installed to extend from the road Rd to the visit destination facility V and gates 300-in and 300-out are installed on the gate passage 300G. An entry sensor that detects a vehicle entering the parking facility P is provided in the gate 300-in and transmits entry information to the parking lot management apparatus 400 when a vehicle entering the parking facility P is detected.

The round passage 300R is installed in a round shape (oval shape) and reaches the front of the gate passage 300G. An alighting place 330 including a stop area 310 and a boarding/alighting area 320 is provided in proximity to the visit destination facility V in the round passage 300R. The stop area 310 is set in a part of the round passage 300R facing the visit destination facility V and the boarding/alighting area 320 is provided between the visit destination facility V and the stop area 310. An eaves for taking shelter from the rain or snow is provided in the boarding/alighting area 320.

The stop area 310 is provided on a long side of one side of the round passage 300R and the parking lot PA is provided by a long side of the other side. The connecting passage 300C that connects the round passage 300R and the parking lot PA is connected to a position of the round passage 300R which neighbors the parking lot PA. The parking lot PA has an approximately rectangular shape and is provided along the long side of the round passage 300R. The parking lot management apparatus 400 is installed at a position at which three sides thereof are surrounded by the round passage 300R, the connecting passage 300C, and the parking lot PA. A plurality of parking spaces PS are provided in the parking lot PA.

An occupant U who has alighted from a host vehicle M is located in the boarding/alighting area 320. The occupant U may be, for example, a user who is provided with services according to the parking lot management apparatus 400. The occupant U possesses the terminal device 250, for example. The occupant U transmits an exit reservation time or performs an operation of triggering start of a self-driving parking event using the terminal device 250.

### [Vehicle System 1]

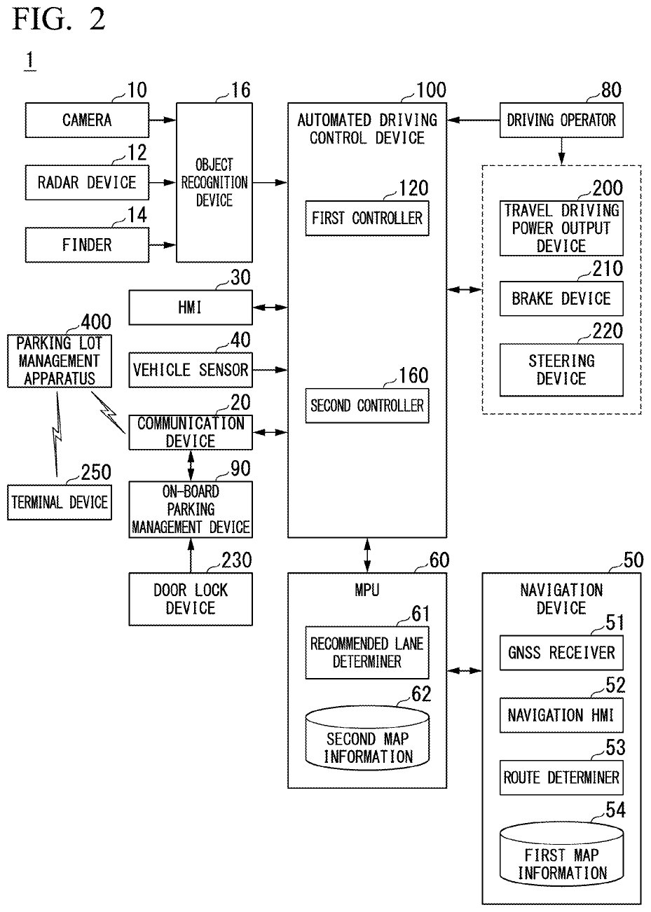

Next, the vehicle system will be described. FIG. 2 is a configuration diagram of a vehicle system 1. For example, a vehicle equipped with the vehicle system 1 is a two-wheeled, three-wheeled, four-wheeled vehicle or the like and a driving source thereof includes an internal combustion engine such as a diesel engine, or a gasoline engine, a motor or a combination thereof. The motor operates using power generated by a generator connected to the internal combustion engine or power discharged from a secondary battery or a fuel battery.

For example, the vehicle system 1 may include a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, the on-board parking management device 90, an automated driving control device 100, a travel driving power output device 200, a brake device 210, and a steering device 220. These devices and apparatuses are connected through a multiplex communication line such as a controller area network (CAN) communication line, and a serial communication line, a wireless communication network, and the like. The configuration shown in FIG. 1 is merely an example and a part of the configuration may be omitted or other configurations may be further added.

For example, the camera 10 may be a digital camera using a solid state imaging device such as a charge coupled device (CCD) or a complementary metal oxide semiconductor (CMOS). The camera 10 is attached to any portion of a vehicle in which the vehicle system 1 is mounted (hereinafter, a host vehicle M). When a front view image is captured, the camera 10 is attached to the upper part of the front windshield, the rear side of a rear view mirror, or the like. For example, the camera 10 may periodically repeatedly capture images of the surroundings of the host vehicle M. The camera 10 may be a stereo camera.

The radar device 12 radiates electric waves such as millimeter waves to the surroundings of the host vehicle M and detects electric waves (reflected waves) reflected by an object to detect at least the position (distance and direction) of the object. The radar device 12 is attached to any portion of the host vehicle M. The radar device 12 may detect the position and speed of an object according to a frequency modulated continuous wave (FM-CW) method.

The finder 14 is a light detection and ranging (LIDAR) device. The finder 14 radiates light to the surroundings of the host vehicle M and measures scattering light. The finder 14 detects a distance to a target on the basis of a time from light emission to light reception. Radiated light may be pulsed laser light, for example. The finder 14 is attached to any portion of the host vehicle M.

The object recognition device 16 performs a sensor fusion process on detection results of some or all of the camera 10, the radar device 12 and the finder 14 to recognize the position, type, speed and the like of an object. The object recognition device 16 outputs a recognition result to the automated driving control device 100. The object recognition device 16 may output detection results of the camera 10, the radar device 12 and the finder 14 to the automated driving control device 100 as they are. The object recognition device 16 may be omitted from the vehicle system 1.

The communication device 20 communicates with other vehicles present around the host vehicle M or the parking lot management apparatus 400 using a cellular network, a Wi-Fi network, Bluetooth (registered trademark), dedicated short range communication (DSRC) and the like, for example.

The HMI 30 presents various types of information to an occupant of the host vehicle M and receives an input operation from the occupant. The HMI 30 includes various display devices, a speaker, a buzzer, a touch panel, switches, keys, and the like.

The vehicle sensor 40 includes a vehicle speed sensor that detects the speed of the host vehicle M, an acceleration sensor that detects an acceleration, a yaw rate sensor that detects an angular velocity around a vertical axis, a heading sensor that detects the direction of the host vehicle M, etc.

The navigation device 50 may include a global navigation satellite system (GNSS) receiver 51, a navigation HMI 52 and a route determiner 53, for example. The navigation device 50 stores first map information 54 in a storage device such as a hard disk drive (HDD) or a flash memory. The GNSS receiver 51 identifies the position of the host vehicle M on the basis of signals received from GNSS satellites. The position of the host vehicle M may be identified or complemented by an inertial navigation system (INS) using the output of the vehicle sensor 40. The navigation HMI 52 includes a display device, a speaker, a touch panel, keys, etc. A part or all of the navigation HMI 52 and the aforementioned HMI 30 may be made to be common. The route determiner 53 determines a route (hereinafter, a route on a map) to a destination input by an occupant using the navigation HMI 52 from the position of the host vehicle M identified by the GNSS receiver 51 (or any input position) with reference to the first map information 54, for example. The first map information 54 is information representing road shapes according to links indicating roads and nodes connected by links, for example. The first map information 54 may include curvatures and point of interest (POI) information of roads, and the like. A route on a map is output to the MPU 60. The navigation device 50 may perform route guidance using the navigation HMI 52 on the basis of roads on a map. For example, the navigation device 50 may be realized by functions of a terminal device possessed by the occupant, such as a smartphone or a tablet terminal. The navigation device 50 may transmit a current position and a destination to a navigation server through the communication device 20 and acquire the same route as a route on a map from the navigation server.

The MPU 60 includes a recommended lane determiner 61, for example, and stores second map information 62 in a storage device such as an HDD or a flash memory. The recommended lane determiner 61 divides a route on a map provided from the navigation device 50 into a plurality of blocks (divides the route into intervals of 100 m in a vehicle traveling direction, for example) and determines a recommended lane for each block with reference to the second map information 62. The recommended lane determiner 61 performs determination in such a manner that on which lane from the left the vehicle will travel is determined. When a route on a map includes a branch point, the recommended lane determiner 61 determines recommended lanes such that the host vehicle M can travel on a reasonable route for traveling to a branch destination.

The second map information 62 is map information with higher-accuracy than the first map information 54. For example, the second map information 62 may include information on the centers of lanes, information on the boundaries of lanes or the like. The second map information 62 may include road information, traffic regulations information, address information (addresses and zip codes), facility information, telephone number information, etc. The second map information 62 may be updated at any time through communication between the communication device 20 and other devices.

The driving operator 80 includes, for example, an accelerator pedal, a brake pedal, a shift lever, a steering wheel, a modified steering wheel, a joystick and other operators. A sensor that detects an operation amount or presence or absence of an operation is attached to the driving operator 80 and a detection result thereof is output to the automated driving control device 100 or some or all of the travel driving power output device 200, the brake device 210 and the steering device 220.

The on-board parking management device 90 includes, for example, a touch panel, a numeric keypad, a speaker, and the like. The touch panel and the numeric keypad are on-board input devices through which an occupant U inputs information. The touch panel is a display that displays information. The speaker provides information using audio to the occupant U. The display may be a liquid crystal display (LCD) or the like instead of or in addition to the touch panel, and the on-board parking management device 90 generates reservation information about the parking facility P for parking the host vehicle M and an entry/exit time and the like of the host vehicle M according to an operation of the touch panel or the like by the occupant U. The on-board parking management device 90 transmits the generated reservation information to the parking lot management apparatus 400 using the communication device 20.

When the host vehicle M is an unreserved vehicle that has not transmitted exit reservation time to the parking lot management apparatus 400 when entering the parking facility P, the on-board parking management device 90 receives request information transmitted by the parking lot management apparatus 400 using a communicator 410. The request information is information for requesting designation (input) of an exit reservation time by the occupant U. When the request information is received, the on-board parking management device 90 provides the received request information to the occupant U by displaying the received request information on the touch panel or outputting it using audio through the speaker. When the on-board parking management device 90 generates reservation information on the basis of an operation of the touch panel or the like by the occupant U after the request information is provided, the on-board parking management device 90 transmits the generated reservation information to the parking lot management apparatus 400.

The on-board parking management device 90 acquires the request information and the exit reservation time transmitted from the parking lot management apparatus 400 and performs controls of causing the display to display the acquires the request information and the exit reservation time. When the exit reservation time is caused to be displayed, the on-board parking management device 90 may cause display for requesting that the occupant U confirm the exit reservation time and then transmit confirmation information and display of acquisition of useful information according to transmission of the confirmation information to be performed. For example, the on-board parking management device 90 generates confirmation information according to an operation of the occupant and transmits the confirmation information to the parking lot management apparatus 400 after confirming the exit reservation time transmitted from the parking lot management apparatus 400.

The automated driving control device 100 includes, for example, a first controller 120 and a second controller 160. Each of the first controller 120 and the second controller 160 is realized by a hardware processor such as a central processing unit (CPU) executing a program (software), for example. Some or all of these components may be realized by hardware (circuit device; including circuitry) such as a large scale integration (LSI) circuit, an application specific integrated circuit (ASIC), a field-programmable gate array (FPGA) and a graphics processing unit (GPU) or realized by software and hardware in cooperation. Programs may be stored in advance in a storage device (storage device including a non-transitory storage medium) of the automated driving control device 100, such as an HDD or a flash memory, or stored in a detachable storage medium such as a DVD or a CD-ROM and installed in the HDD or the flash memory of the automated driving control device 100 by setting the storage medium (non-transitory storage medium) in a drive device.

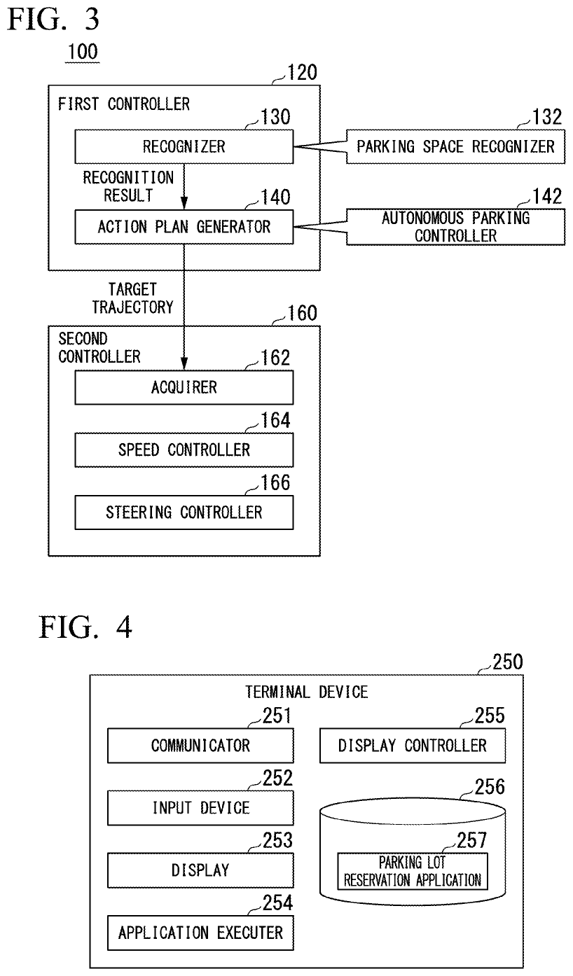

FIG. 3 is a functional configuration diagram of the first controller 120 and the second controller 160. The first controller 120 includes, for example, a recognizer 130 and an action plan generator 140. The first controller 120 may realize a function using artificial intelligence (AI) and a function using a model provided in advance in parallel, for example. For example, a function of “recognizing an intersection” may be realized by performing recognition of an intersection using deep learning or the like and recognition based on conditions provided in advance (which include a signal which can be pattern-matched, road markings and the like) in parallel and assigning scores to both the recognitions to integrally evaluate the recognitions. Accordingly, reliability of automated driving is secured.

The recognizer 130 recognizes states such as the position, speed and acceleration of an object around the host vehicle M on the basis of information input from the camera 10, the radar device 12 and the finder 14 through the object recognition device 16. For example, the position of an object may be recognized as a position on absolute coordinates having a representative point (the center of gravity, the center of the drive shaft or the like) of the host vehicle M as the origin and used for control. The position of an object may be represented as a representative point of the object, such as the center of gravity or a corner, or may be represented as a representative region. “States” of an object may include the acceleration and jerk of the object or an “action state” (e.g., whether lane change is being performed or is intended to be performed).

The recognizer 130 recognizes a lane (traveling lane) in which the host vehicle M is traveling, for example. For example, the recognizer 130 may recognize a traveling lane by comparing a lane marking pattern (e.g., arrangement of solid lines and dashed lines) obtained from the second map information 62 with a lane marking pattern around the host vehicle M recognized from an image captured by the camera 10. The recognizer 130 may recognize a traveling lane by recognizing lane boundaries (road boundaries) including lane markings, road shoulders, curbs, medians, guardrails and the like as well as lane markings. In such recognition, the position of the host vehicle M acquired from the navigation device 50 and a processing result of the INS may be additionally taken into account. The recognizer 130 recognizes temporary stop lines, obstacles, a red signal, tollgates, and other road states.

The recognizer 130 recognizes a position and an attitude of the host vehicle M with respect to a traveling lane when the traveling lane is recognized. For example, the recognizer 130 may recognize a distance between a reference point of the host vehicle M and the center of the lane and an angle between a traveling direction of the host vehicle M and a line connecting the center of the lane as a relative position and attitude of the host vehicle M with respect to the traveling lane. Instead of this, the recognizer 130 may recognize the position of the reference point of the host vehicle M or the like with respect to any side edge of the traveling lane (a lane marking or a road boundary) as a relative position of the host vehicle M with respect to the traveling lane.

The action plan generator 140 generates a target trajectory through which the host vehicle M will automatically travel (without depending on an operation of a driver) in the future such that the host vehicle M travels in a recommended lane determined by the recommended lane determiner 61 in principle and can cope with a surrounding situation thereof. For example, a target trajectory may include a speed factor. For example, a target trajectory is represented as a sequential arrangement of points (trajectory points) at which the host vehicle M will arrive. A trajectory point is a point at which the host vehicle M will arrive for each predetermined traveling distance (e.g., approximately several meters) in a distance along a road, and a target speed and a target acceleration for each predetermined sampling time (e.g., every several tens of a second) are generated as a part of a target trajectory apart from trajectory points. A trajectory point may be a position at which the host vehicle M will arrive at a sampling time for each predetermined sampling time. In this case, information on a target speed and a target acceleration is represented by a spacing between trajectory points.

The action plan generator 140 may set an automated driving event upon generation of a target trajectory. Automated driving events include a constant-speed traveling event, a constant-speed takeover event, a lane change event, a branch event, a merging event, a takeover event, a self-driving parking event of parking in a parking lot through unmanned traveling, such as valet parking, and the like. The action plan generator 140 generates a target trajectory in response to a started event. The action plan generator 140 includes a autonomous parking controller 142 that starts when the self-driving parking event is executed. Functions of the autonomous parking controller 142 will be described in detail later.

The second controller 160 controls the travel driving power output device 200, the brake device 210, and the steering device 220 shown in FIG. 2 such that the host vehicle M passes through a target trajectory generated by action plan generator 140 on scheduled time.

Referring back to FIG. 3, the second controller 160 includes, for example, an acquirer 162, a speed controller 164 and a steering controller 166. The acquirer 162 acquires information on a target trajectory (trajectory points) generated by the action plan generator 140 and stores the information on a memory (not shown). The speed controller 164 controls the travel driving power output device 200 or the brake device 210 on the basis of a speed factor belonging to the target trajectory stored in the memory. The steering controller 166 controls the steering device 220 in response to a degree of bending of the target trajectory stored in the memory. Processing of the speed controller 164 and the steering controller 166 is realized by feedforward control and feedback control in combination, for example. As an example, the steering controller 166 performs feedforward control according to a curvature of a road ahead of the host vehicle M and feedback control based on a distance from a target trajectory in combination.

The travel driving power output device 200 outputs a travel driving power (torque) necessary for the host vehicle M to travel to driving wheels. The travel driving power output device 200 includes, for example, a combination of an internal combustion engine, a motor, a transmission, and the like and an electronic control unit (ECU) which controls the combination. The ECU controls the aforementioned components according to information input from the second controller 160 or information input from the driving operator 80.

The brake device 210 includes, for example, a brake caliper, a cylinder which transfers a hydraulic pressure to the brake caliper, an electric motor which generates a hydraulic pressure in the cylinder, and a brake ECU. The brake ECU controls the electric motor according to information input from the second controller 160 and information input from the driving operator 80 such that a brake torque according to the braking operation is output to each vehicle wheel. The brake device 210 may include a mechanism for transferring a hydraulic pressure generated by an operation of a brake pedal included in the driving operator 80 to the cylinder through a master cylinder as a backup. The brake device 210 is not limited to the above-described configuration and may be an electronically controlled hydraulic brake device which controls an actuator according to information input from the second controller 160 and transfers a hydraulic pressure of a master cylinder to a cylinder.

The steering device 220 includes, for example, a steering ECU and an electric motor. For example, the electric motor may change the direction of the steering wheel by applying a force to a rack-and-pinion mechanism. The steering ECU drives the electric motor according to information input from the second controller 160 or information input from the driving operator 80 to change the direction of the steering wheel.

A door lock device 230 is provided in doors of the host vehicle M and generates a door lock state in which doors are locked and an unlock state in which doors are unlocked. The door lock device 230 includes a door lock sensor. The door lock sensor detects door lock of the host vehicle M which is externally performed. The door lock sensor outputs door lock information to the on-board parking management device 90 when door lock is detected. When the doors of the host vehicle M are externally locked in the alighting place 330 and the door lock sensor outputs door lock information, the on-board parking management device 90 transmits the output door lock information to the parking lot management apparatus 400 using the communication device 20.

### [Terminal Device 250]

FIG. 4 is a diagram showing an example of a functional configuration of the terminal device 250. The terminal device 250 includes, for example, a communicator 251, an input device 252, a display 253, an application executer 254, a display controller 255, and a storage 256. The communicator 251, the input device 252, the display 253, the application executer 254, and the display controller 255 are realized, for example, by a hardware processor such as a CPU executing a program (software). Some or all of these components may be realized by hardware (circuit device; including circuitry) such as an LSI, an ASIC, an FPGA or a GPU or realized by software and hardware in cooperation. The aforementioned program may be stored in advance in a storage device (storage device including a non-transitory storage medium) of the terminal device 250, such as an HDD or a flash memory, or stored in a detachable storage medium such as a DVD or a CD-ROM and installed in the storage 256 by setting the storage medium (non-transitory storage medium) in a drive device.

The communicator 251 performs communication with the parking lot management apparatus 400 and other external devices via a local area network (LAN), a wide area network (WAN) or a network of the Internet, for example. The input device 252 is a terminal input device and, for example, receives input of the occupant U according to operation of various keys, buttons, and the like. The display 253 is an LCD or the like, for example. The input device 252 may be integrated with the display 253 as a touch panel.

The application executer 254 is realized according to execution of a parking lot reservation application 257 stored in the storage 256. For example, the parking lot reservation application 257 performs communication with the parking lot management apparatus 400 via a network to acquire request information transmitted from the parking lot management apparatus 400 and causes the display 253 to display the request information. The parking lot reservation application 257 is, for example, an application program that generates the same reservation information and confirmation information as reservation information and confirmation information transmitted from the on-board parking management device 90 to the parking lot management apparatus 400 and transmits the generated information to the parking lot management apparatus 400. The reservation information is generated, for example, by the occupant U operating the input device 252 before or after the vehicle enters the parking facility P. The confirmation information is generated, for example, by the occupant U operating the input device 252 after exit reservation time is received. Furthermore, the parking lot reservation application 257 may perform display for requesting that the occupant U confirm the exit reservation time and then transmit confirmation information and display of acquisition of useful information according to transmission of the confirmation information.

The display controller 255 controls details to be displayed on the display 253 and a display timing. For example, the display controller 255 generates an image for displaying information generated by executing the application executer 254 on the display 253 and causes the display 253 to display the generated image. As information generated by executing the application executer 254, for example, there is information related to request information and an exit reservation time transmitted from the parking lot management apparatus 400, for example, information for causing the display 253 to display information on the exit reservation time. Information related to the exit reservation time may be a time before or after the exit reservation time, for example, 10 minutes before the exit reservation time, or the like. The display controller 255 may generate an audio associated with some or all of details displayed on the display 253 and cause the generated audio to be output through a speaker (not shown) of the terminal device 250. The display controller 255 may cause the display 253 to display an image received from the parking lot management apparatus 400 or cause the speaker to output an audio received from the parking lot management apparatus 400.

The storage 256 is realized, for example, by an HDD, a flash memory, an EEPROM, a ROM, a RAM, or the like. For example, the parking lot reservation application 257 and other types of information are stored in the storage 256.

### [Parking Lot Management Apparatus 400]

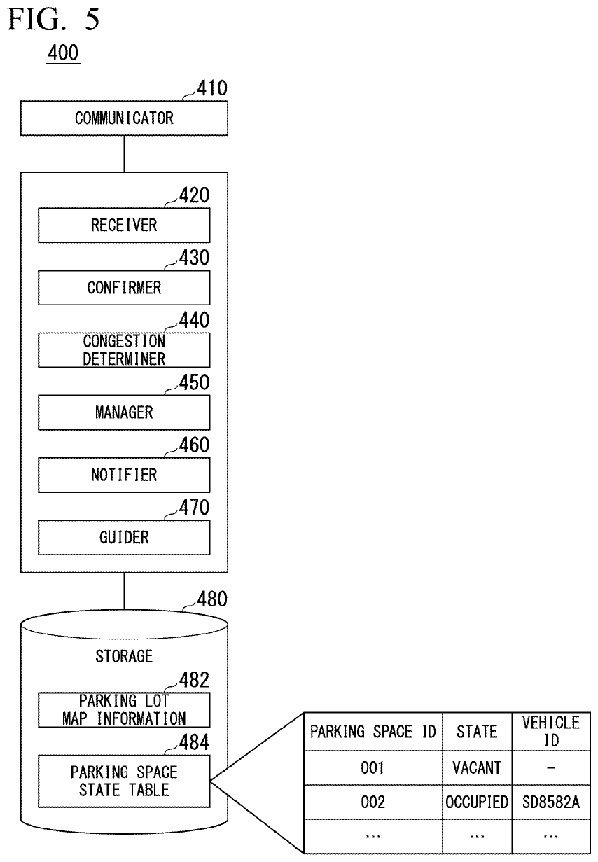

FIG. 5 is a diagram showing an example of a configuration of the parking lot management apparatus 400. The parking lot management apparatus 400 includes, for example, the communicator 410, a receiver 420, a confirmer 430, a congestion determiner 440, a manager 450, a notifier 460, a guider 470, and a storage 480. The receiver 420, the confirmer 430, the congestion determiner 440, the manager 450, the notifier 460, and the guider 470 are realized, for example, by a hardware processor such as a CPU executing a program (software). Some or all of these components may be realized by hardware (circuit device; including circuitry) such as an LSI, an ASIC, an FPGA or a GPU or realized by software and hardware in cooperation. The aforementioned program may be stored in advance in a storage device (storage device including a non-transitory storage medium) of the automated driving control device 100, such as an HDD or a flash memory, or stored in a detachable storage medium such as a DVD or a CD-ROM and installed in the HDD or the flash memory of the automated driving control device 100 by setting the storage medium (non-transitory storage medium) in a drive device. The storage 480 stores information such as parking lot map information 482 and a parking space state table 484.

The communicator 410 wirelessly communicates with vehicles present around the parking lot management apparatus 400 and other devices such as other terminal devices or various server devices using a cellular network, a Wi-Fi network, Bluetooth (registered trademark), DSRC, or the like. The communicator 410 is assumed to be able to communicate with vehicles in the parking facility P.

The receiver 420 receives reservation information transmitted from the on-board parking management device 90 and the terminal device 250 by receiving it using the communicator 410. When the reservation information is received, the receiver 420 stores various types of information included in the reservation information, for example, an entry reservation time, an exit reservation time, and the like of a vehicle, in the storage 480. Further, when the receiver 420 receives entry information transmitted from the entry sensor provided at the gate 300-in using the communicator 410, the receiver 420 determines that a vehicle has entered the parking facility P.

The confirmer 430 confirms whether an exit reservation time at which a parking standby vehicle intended to be parked in the parking lot PA will exit from the parking lot PA has been designated. When the exit reservation time of the parking standby vehicle has been designated, the confirmer 430 generates reservation completion information and outputs the reservation completion information to the manager 450. When the exit reservation time of the parking standby vehicle has not been designated, the confirmer 430 generates non-reservation information and outputs the non-reservation information to the manager 450.

The congestion determiner 440 determines whether in front of the alighting place 330 is congested and whether a specific vehicle, for example, the host vehicle M, is in the congestion. For example, the congestion determiner 440 may acquire an image of an inside camera that is not shown and which images the inside of the parking facility P, performs image processing on the acquired image and checks states of vehicles in front of the alighting place 330. The congestion determiner 440 checks the number of vehicles and the speed of each vehicles, for example, as states of vehicles. The congestion determiner 440 outputs results of determination of whether in front of the alighting place 330 is congested and whether a specific vehicle is in the congestion to the manager 450. The congestion determiner 440 may determine congestion according to other methods or determine congestion, for example, on the basis of a difference between the number of vehicles that have entered the parking facility P and the number of vehicles that have started parking in the parking lot PA from the alighting place 330, information acquired by a parking lot manager or the like according to visual observation, and the like. Furthermore, the congestion determiner 440 also determines whether a vehicle has arrived at the alighting place 330.

The manager 450 generates notification information and guidance start information on the basis of an exit reservation time stored in the storage 480, reservation completion information and non-reservation information transmitted from the confirmer 430, and determination results transmitted from the congestion determiner 440. The manager 450 transmits the generated notification information to the notifier 460. The manager 450 outputs the generated guidance start information to the guider 470.

Further, the manager 450 assigns usage conditions at the time of parking at the parking lot PA to an occupant of a vehicle. The usage conditions include, for example, usage conditions with reservation and usage conditions without reservation, and the usage conditions with reservation are more advantageous for an occupant of a vehicle than the usage conditions without reservation. For example, the usage conditions with reservation provide a lower parking fee than the usage conditions without reservation. The manager 450 is an example of an “assigner.”

Further, the manager 450 determines whether an occupant has alighted from a vehicle. For example, the manager 450 determines whether an occupant has alighted from a vehicle according to whether the manager 450 has received door lock information transmitted from the on-board parking management device 90 of the vehicle. The manager 450 receives the door lock information and determines that the occupant has alighted from the vehicle when the doors of the vehicle are locked.

The notifier 460 generates request information for requesting input of an exit reservation time on the basis of notification information output from the manager 450. The notifier 460 transmits the generated request information to the on-board parking management device 90 or the terminal device 250. In this case, the notifier 460 may transmit the request information to any of the on-board parking management device 90 and the terminal device 250 or both the on-board parking management device 90 and the terminal device 250.

Further, the notifier 460 generates useful information when confirmation information transmitted from a vehicle has been received through the communicator 410 after transmission of the request information. The notifier 460 transmits the generated useful information to the vehicle that has transmitted the confirmation information through the terminal device 250 of the occupant using the communicator 410. The useful information is information useful for an occupant of a vehicle and includes, for example, bargain information when the visit destination facility V is a shopping center, information on a gate through which a vehicle can easily exit when the parking facility PA has a plurality of gates, information on a position in the boarding/alighting area 320 at which an occupant may easily board a vehicle that has exited from the parking lot PA and arrived at the stop area 310, and the like.

The guider 470 guides a vehicle to a parking space PS that is a target position on the basis of information acquired from the communicator 410 and information stored in the storage 480 after the guidance start information is output from the manager 450. The parking lot map information 482 is information geometrically representing the structure of the parking lot PA. The parking lot map information 482 includes coordinates of each parking space PS. In the parking space state table 484, for example, a state indicating a vacant state or an occupied (parked) state and a vehicle ID that is identification information of a parked vehicle in a case of the occupied state are associated with a parking space ID that is identification information of a parking space PS.

When the communicator 410 receives a parking request from a vehicle, the guider 470 extracts a parking space PS in a vacant state with reference to the parking space state table 484, acquires the position of the extracted parking space PS from the parking lot map information 482, transmits a suitable route to the acquired position of the parking space PS to the vehicle using the communicator 410 and guides the vehicle to the parking space PS. When the guider 470 guides a vehicle, the guider 470 instructs a specific vehicle to stop or slowly travel as necessary such that vehicles do not simultaneously travel to the same position on the basis of positional relationships between a plurality of vehicles.

In the vehicle that has received the route (hereinafter referred to as the host vehicle M), the autonomous parking controller 142 generates a target trajectory based on the route. When the vehicle approaches the parking space PS that is the target, a parking space recognizer 132 recognizes a parking frame line that defines the parking space PS, recognizes the detailed position of the parking space PS and provides the detailed position of the parking space PS to the autonomous parking controller 142. The autonomous parking controller 142 receives the detailed position of the parking space PS, corrects the target trajectory and parks the host vehicle M at the parking space PS.

### [Autonomous Parking Event: At Time of Entrance]

The autonomous parking controller 142 may cause the host vehicle M to be parked in a parking space on the basis of information acquired from the parking lot management apparatus 400 through the communication device 20, for example. As shown in FIG. 1, the host vehicle M passes through the gate 300-in and moves to the stop area 310 according to manual driving or automated driving. The host vehicle M performs unmanned automated driving after an occupant alights from the host vehicle M in the stop area 310 and starts a self-driving parking event for moving to a parking space PS in the parking lot PA. A self-driving parking event starting trigger may be an operation performed by the occupant or wireless reception of a predetermined signal from the parking lot management apparatus 400, for example. The autonomous parking controller 142 controls the communication device 20 such that it transmits a parking request to the parking lot management apparatus 400 when the self-driving parking event is started. Then, the host vehicle M moves from the stop area 310 to the parking lot PA according to guidance of the parking lot management apparatus 400 or while performing sensing by itself.

### [Autonomous Parking Event: At Time of Return]

The autonomous parking controller 142 and the communication device 20 maintain operating states even when the host vehicle M is parked. For example, when the communication device 20 has received a pickup request from a terminal device of an occupant, the autonomous parking controller 142 starts the system of the host vehicle M and causes the host vehicle M to move to the stop area 310. Here, the autonomous parking controller 142 controls the communication device 20 such that it transmits a departure request to the parking lot management apparatus 400. The guider 470 of the parking lot management apparatus 400 instructs a specific vehicle to stop, slow down or the like as necessary such that vehicles do not simultaneously advance to the same position on the basis of a positional relation of a plurality of vehicles as in vehicle entry. When the host vehicle M moves to the stop area 310 and the user boards the host vehicle M, the autonomous parking controller 142 stops operation, and then manual driving or automated driving by a separate functional part is started.

The present invention is not limited to the above description and the autonomous parking controller 142 may discover a parking space in a vacant state by itself and cause the host vehicle M to stop in the discovered parking space on the basis of a detection result of the camera 10, the radar device 12, the finder 14, or the object recognition device 16.

Next, a first embodiment and a second embodiment of processing executed in the parking lot management apparatus 400 will be described.

### First Embodiment

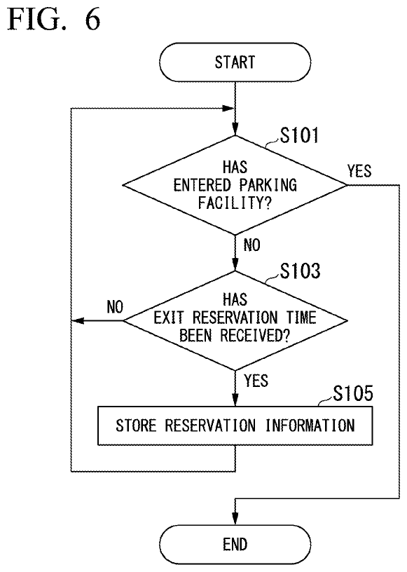

FIG. 6 to FIG. 8 are flowcharts showing an example of processing of the first embodiment in the parking lot management apparatus 400. Processing until the host vehicle M enters the parking facility P, processing until the host vehicle M arrives at the alighting place 330, and processing until the occupant U alights from the host vehicle M will be separately described below.

### [Processing Until Host Vehicle M Enters Parking Facility P]

Processing of the parking lot management apparatus 400 until the host vehicle M enters the parking facility P will be described with reference to FIG. 6. In processing shown in FIG. 6, the receiver 420 determines whether the host vehicle M has entered the parking facility P (step S101). When it is determined that the host vehicle has not entered the parking facility P, the receiver 420 receives reservation information transmitted from the host vehicle M or the terminal device 250 and determines whether designation of an exit reservation time has been received (step S103).

When it is determined that designation of the exit reservation time has been received, the receiver 420 stores reservation information including the exit reservation time in the storage 480 (step S105). Here, when reservation information has already been stored, the reservation information is updated. Thereafter, the receiver 420 returns to the process of step S101. When it is determined that designation of the exit reservation time has not been received in step S103, the receiver 420 returns to the process of step S101. When it is determined that the host vehicle M has entered the parking facility P in step S101, the receiver 420 ends processing shown in FIG. 6.

### [Processing Until Host Vehicle M Arrives at Alighting Place 330]

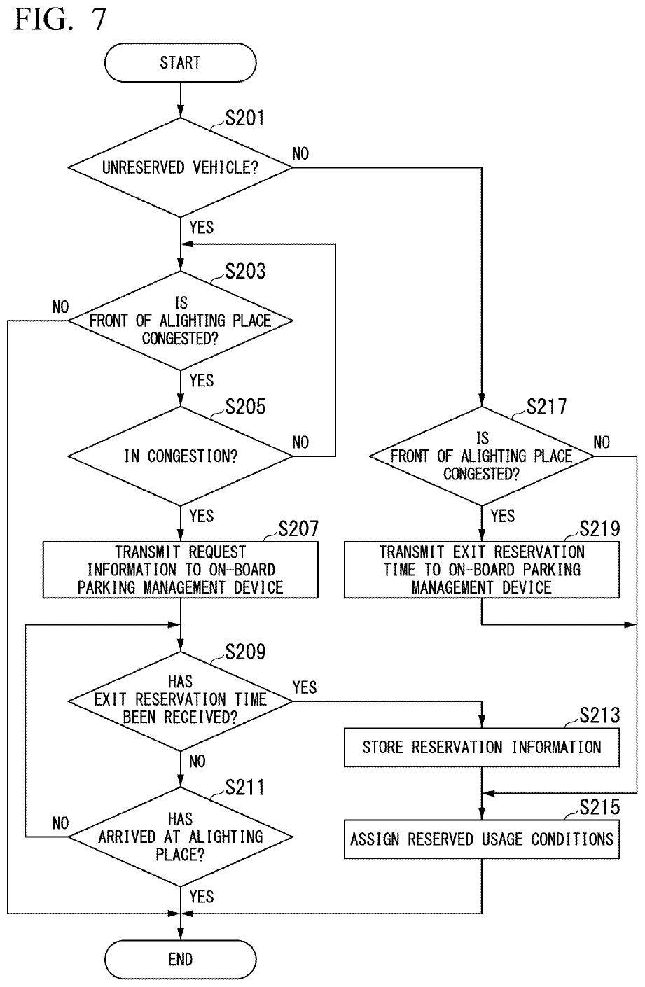

Next, processing of the parking lot management apparatus 400 until the host vehicle M arrives at the alighting place 330 will be described with reference to FIG. 7. In processing shown in FIG. 7, the confirmer 430 determines whether the host vehicle M is an unreserved vehicle for which an exit reservation time is not stored in the storage 480 (a vehicle for which reservation has not been performed) (step S201). When it is determined that the host vehicle M is an unreserved vehicle, the congestion determiner 440 determines whether in front of the alighting place 330 is congested (step S203).

When it is determined that in front of the alighting place 330 is not congested, the congestion determiner 440 ends processing shown in FIG. 7. When it is determined that in front of the alighting place 330 is congested, the congestion determiner 440 determines whether the host vehicle M is in the congestion (step S205). When it is determined that the host vehicle M is not in the congestion, the congestion determiner 440 returns to the process of step S203.

When it is determined that the host vehicle M is in the congestion, the notifier 460 generates request information and transmits the generated request information to the host vehicle M using the communicator 410 (step S207). The on-board parking management device 90 that has received the request information provides the request information to the occupant U through the display. The occupant U who has received provision of the request information may transmit reservation information through the on-board parking management device 90 or the terminal device 250 or may not transmit the reservation information.

Next, the receiver 420 receives the reservation information transmitted from the host vehicle M or the terminal device 250 and determines whether designation of an exit reservation time has been received (step S209). When it is determined that designation of the exit reservation time has not been received, the congestion determiner 440 determines whether the host vehicle M has arrived at an alighting area (step S211).

When it is determined that the host vehicle M has not arrived at the alighting place 330, the congestion determiner 440 returns to the process of step S209. When it is determined that the host vehicle M has arrived at the alighting place 330, the congestion determiner 440 ends processing shown in FIG. 7.

When it is determined that designation of the exit reservation time has been received in step S209, the receiver 420 stores reservation information including the exit reservation time in the storage 480. Here, when reservation information has already been stored, the reservation information is updated (step S213). Thereafter, the manager 450 assigns reserved usage conditions to the occupant U (step S215) and ends processing shown in FIG. 7.

When it is determined that the host vehicle M is not an unreserved vehicle (a vehicle for which reservation has been performed) in step S201, the congestion determiner 440 determines whether in front of the alighting place 330 is congested (step S217). When it is determined that in front of the alighting place 330 is congested, the notifier 460 transmits an exit reservation time to the on-board parking management device 90 (step S219). The exit reservation time is transmitted to the on-board parking management device 90 so that the occupant U can confirm the exit reservation time. Thereafter, the manager 450 assigns the reserved usage conditions to the occupant U (step S215) and ends processing shown in FIG. 7. When it is determined that in front of the alighting place 330 is not congested, the manager 450 directly ends processing shown in FIG. 7.

[Processing Until Occupant U Alights from Host Vehicle M]

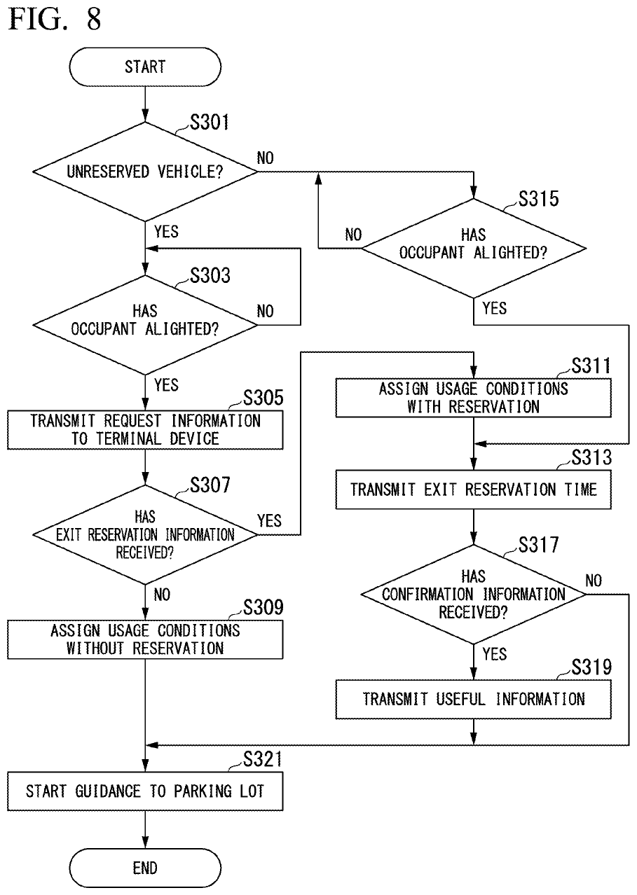

Next, processing of the parking lot management apparatus 400 until the occupant U alights from the host vehicle M will be described with reference to FIG. 8. In processing shown in FIG. 8, the confirmer 430 confirms whether the host vehicle M is an unreserved vehicle for which an exit reservation time is not stored in the storage 480 (step S301). When it is determined that the host vehicle M is an unreserved vehicle, the manager 450 determines whether the occupant U has alighted from the host vehicle M (step S303).

When it is determined that the occupant U has not alighted from the host vehicle M, the manager 450 repeats the process of step S303. When it is determined that the occupant U has alighted from the host vehicle M, the notifier 460 generates request information and transmits the generated request information to the terminal device 250 of the occupant U using the communicator 410 (step S305). The terminal device 250 that has received the request information provides the request information to the occupant U through the display 253. The occupant U who has received provision of the request information may or may not transmit reservation information through the terminal device 250.

Next, the receiver 420 receives the reservation information transmitted from the terminal device 250 and determines whether designation of an exit reservation time has been received (step S307). When it is determined that designation of an exit reservation time has not been received, the manager 450 assigns usage conditions without reservation to the occupant U (step S309) and proceeds to step S319.

When it is determined that designation of an exit reservation time has been received, the manager 450 assigns the usage conditions with reservation to the occupant U (step S311). Then, the notifier 460 transmits the exit reservation time to the terminal device 250 of the occupant U using the communicator 410 (step S313).

When it is determined that the host vehicle M is not an unreserved vehicle in step S301, the manager 450 determines whether the occupant U has alighted from the host vehicle M (step S315). When it is determined that the occupant U has not alighted from the host vehicle M, the manager 450 repeats the process of step S315 until the occupant U has alighted from the host vehicle M. When it is determined that the occupant U has alighted from the host vehicle M, the notifier 460 transmits an exit reservation time to the terminal device 250 of the occupant U using the communicator 410 (step S313). The occupant U who has received the exit reservation time may transmit confirmation information when the exit reservation time has been confirmed through the on-board parking management device 90 or the terminal device 250 of the occupant U or may not transmit confirmation information.

Next, the notifier 460 determines whether the confirmation information transmitted from the on-board parking management device 90 or the terminal device 250 of the occupant U has been received using the communicator 410 (step S317). When it is determined that the confirmation information has been received, the notifier 460 transmits useful information to the on-board parking management device 90 or the terminal device 250 of the occupant U which has transmitted the confirmation information (step S319) and proceeds to step S321. When it is determined that the confirmation information has not been received, the notifier 460 directly proceeds to step S321.

Next, the guider 470 starts guidance of the host vehicle M stopped in the stop area 310 of the alighting place 330 to the parking lot PA (step S321). In this manner, the parking lot management apparatus 400 ends processing shown in FIG. 8.

### Second Embodiment

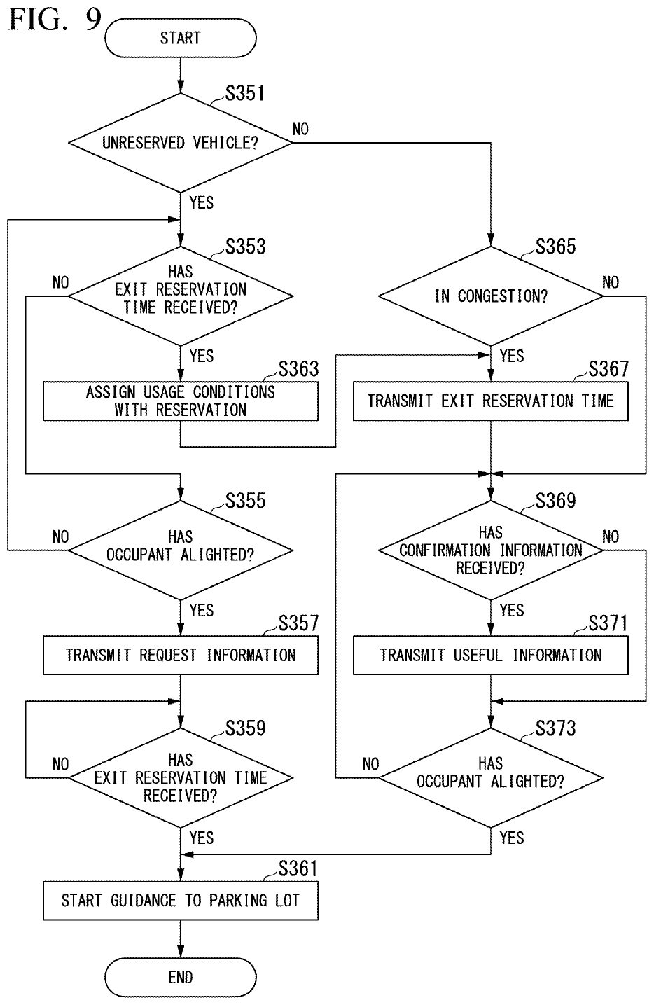

FIG. 9 is a flowchart showing an example of processing of the second embodiment in the parking lot management apparatus 400. The second embodiment differs from the above-described first embodiment with respect to processing until the occupant U alights from the host vehicle M. Accordingly, processing until the occupant U alights from the host vehicle M will be described below.

In processing shown in FIG. 9, the confirmer 430 confirms whether the host vehicle M is an unreserved vehicle for which an exit reservation time is not stored in the storage 480 (step S351). When it is determined that the host vehicle M is an unreserved vehicle, the receiver 420 receives reservation information transmitted from the on-board parking management device 90 or the terminal device 250 and determines whether a scheduled exit time has been received (step S353).

When it is determined that the scheduled exit time has not been received, the manager 450 determines whether the occupant U has alighted from the host vehicle M (step S355). When it is determined that the occupant U has not alighted from the host vehicle M, the manager 450 returns to the process of step S353. When it is determined that the occupant U has alighted from the host vehicle M, the notifier 460 generates request information and transmits the generated request information to the terminal device 250 of the occupant U using the communicator 410 (step S357).

Next, the receiver 420 receives reservation information transmitted from the terminal device 250 and determines whether the scheduled exit time has been received (step S359). When it is determined that designation of the exit reservation time has not been received, the manager 450 repeats the process of step S359. Accordingly, the manager 450 repeats the process of step S359 until the scheduled exit time is received. When it is determined that designation of the exit reservation time has been received, the guider 470 starts guidance of the host vehicle M stopped in the stop area 310 of the alighting place 330 to the parking lot PA (step S361). The guider 470 does not start guidance of the host vehicle M until the receiver 420 receives designation of the exit reservation time through the processes of step S359 and step S361. In this manner, the parking lot management apparatus 400 ends processing shown in FIG. 9.

When it is determined that designation of the exit reservation time has been received, the manager 450 assigns usage conditions with reservation to the occupant U (step S363). Subsequently, the notifier 460 transmits the exit reservation time to the terminal device 250 of the occupant U using the communicator 410 (step S367). When it is determined that the host vehicle M is not an unreserved vehicle (the host vehicle M is a vehicle to which reservation has been performed) in step S351, the manager 450 determines whether in front of the alighting place 330 is congested and the host vehicle M is in the congestion (step S365). When it is determined that the host vehicle M is in the congestion, the notifier 460 transmits an exit reservation time to the on-board parking management device 90 and the terminal device 250 of the occupant U using the communicator 410 (step S367). When it is determined that the host vehicle M is not in the congestion, the manager 450 proceeds to the process of step S369.

Next, the notifier 460 determines whether confirmation information transmitted from the on-board parking management device 90 or the terminal device 250 of the occupant U has been received (step S369). When it is determined that the confirmation information has been received, the notifier 460 transmits useful information to the on-board parking management device 90 or the terminal device 250 of the occupant U that has transmitted the confirmation information (step S371). Subsequently, the manager 450 determines whether the occupant U has alighted from the host vehicle M (step S373).

When it is determined that the occupant U has not alighted from the host vehicle M, the manager 450 returns to step S367. When useful information is transmitted in step S371, transmission of the same useful information is canceled. When it is determined that the occupant U has alighted from the host vehicle M, the guider 470 starts guidance of the host vehicle M stopped in the stop area 310 of the alighting place 330 to the parking lot PA (step S361). In this manner, the parking lot management apparatus 400 ends processing shown in FIG. 9.

The above-described parking lot management apparatus 400 receives designation of an exit reservation time performed by an occupant U of an unreserved vehicle when the unreserved vehicle is in a congestion occurring in front of the alighting place 330. Accordingly, the occupant U of the unreserved vehicle can designate a scheduled exit time for a free time during congestion and thus convenience in a parking lot can be improved. Particularly, when an unreserved vehicle is an automated vehicle, convenience in a parking lot can be further improved.

### [Hardware Configuration]

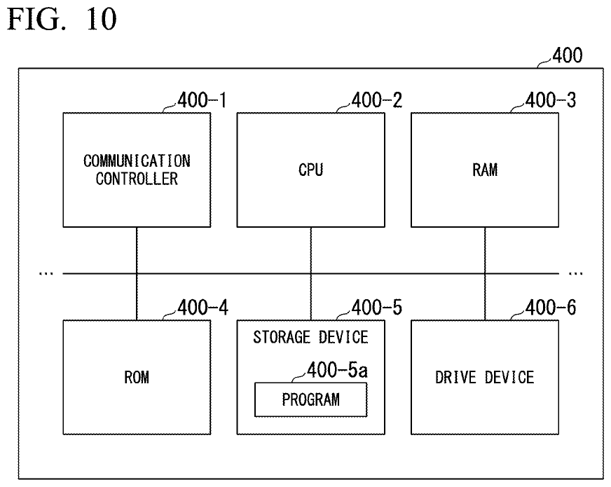

FIG. 10 is a diagram showing an example of a hardware configuration of the parking lot management apparatus 400 of an embodiment. As shown, the parking lot management apparatus 400 is configured in such a manner that a communication controller 400-1, a CPU 400-2, a random access memory (RAM) 400-3 used as a working memory, a read only memory (ROM) 400-4 storing a boot program and the like, a storage device 400-5 such as a flash memory or a hard disk drive (HDD), a drive device 400-6, and the like are connected through an internal bus or a dedicated communication line. The communication controller 400-1 performs communication with components other than the parking lot management apparatus 400. The storage device 400-5 stores a program 400-5a executed by the CPU 400-2. This program is developed in the RAM 400-3 through a direct memory access (DMA) controller (not shown) or the like and executed by the CPU 400-2. Accordingly, some or all of the communicator 410, the receiver 420, the confirmer 430, the congestion determiner 440, the manager 450, the notifier 460, and the guider 470 are realized.

The aforementioned embodiment can be represented as follows.

A parking lot management apparatus comprising:

a storage device storing a program; and

a hardware processor,

wherein the hardware processor is configured to, by executing the program stored in the storage device:

receive designation of an exit reservation time at which a vehicle will exit a parking lot;

confirm whether the exit reservation time has been designated for a vehicle intended to be parked in the parking lot; and

when in front of an alighting place where a user alights from a vehicle to be parked in the parking lot is congested, receive designation of the exit reservation time if an unreserved vehicle for which it is confirmed that the exit reservation time has not been designated is in the congestion.

While forms for embodying the present invention have been described using embodiments, the present invention is not limited to these embodiments and various modifications and substitutions can be made without departing from the spirit or scope of the present invention.

What is claimed is:

1. A parking lot management apparatus comprising:
a processor; and
a memory storing program instructions executable by the processor to:
receive designation of an exit reservation time at which a vehicle will exit a parking lot; and
confirm presence or absence of the designation of the exit reservation time for a vehicle to be parked in the parking lot,
wherein
receiving the designation of the exit reservation time comprises receiving the designation of the exit reservation time with respect to an unreserved vehicle for which it is confirmed that the exit reservation time has not been designated before a user alights from the unreserved vehicle to be parked in the parking lot.

2. The parking lot management apparatus according to claim 1, wherein receiving the designation of the exit reservation time comprises receiving the designation of the exit reservation time in a case where the unreserved vehicle is in congestion which occurs in front of an alighting place.

3. The parking lot management apparatus according to claim 1, wherein receiving the designation of the exit reservation time comprises receiving the designation of the exit reservation time from an on-board input device provided in the vehicle or a terminal input device provided in a terminal device possessed by a user of the vehicle.

4. The parking lot management apparatus according to claim 3, wherein
the program instructions are further executable by the processor to:
guide the vehicle to a target position, and
in a case where the exit reservation time of the unreserved vehicle is reserved at an alighting place where a user alights, in front of which congestion does not occur, guiding the vehicle to the target position comprises starting guidance of the unreserved vehicle after receiving the designation of the exit reservation time from the on-board input device or the terminal input device.

5. The parking lot management apparatus according to claim 4, wherein
the program instructions are further executable by the processor to assign different usage conditions of the parking lot according to presence or absence of designation of the exit reservation time, and
in a case where the designation of the exit reservation time of the unreserved vehicle is not received from the on-board input device or the terminal input device, assigning the usage conditions comprises causing the unreserved vehicle to be parked under usage conditions in a case where it is confirmed that there is no designation of the exit reservation time.

6. The parking lot management apparatus according to claim 4, wherein
the program instructions are further executable by the processor not to start the guidance of the unreserved vehicle in a case where the designation of the exit reservation time of the unreserved vehicle is not received from the on-board input device or the terminal input device.

7. The parking lot management apparatus according to claim 3, wherein:
the program instructions are further executable by the processor to give notification of information; and
in a case where the unreserved vehicle in congestion is to be parked in the parking lot, giving the notification comprises giving notification of a request for designation of the exit reservation time to the on-board input device before giving the notification to the terminal input device.

8. The parking lot management apparatus according to claim 7, wherein, in a case where the unreserved vehicle is to be parked in the parking lot in the alighting place where the user alights, in front of which congestion is not occurring, giving the notification comprises giving notification of a request for designation of the exit reservation time to the terminal input device after the user has alighted from the unreserved vehicle.

9. The parking lot management apparatus according to claim 8, wherein, in a case where input of the exit reservation time from the user has been received before the user alights from the unreserved vehicle, the program instructions are further executable by the processor not to give the notification of the request for designation of the exit reservation time to the terminal input device and give the notification of information related to the receive exit reservation time to the terminal input device.

10. The parking lot management apparatus according to claim 2, wherein:
the program instructions are further executable by the processor to give notification of information; and
in a case where it is confirmed that the exit reservation time has been designated and a reserved vehicle in the congestion is to be parked in the parking lot, giving the notification comprises giving notification of the confirmed exit reservation time to the reserved vehicle.

11. The parking lot management apparatus according to claim 10, wherein:
in a case where confirmation information transmitted from a user who has received the notification of the exit reservation time is acquired, giving the notification comprises giving notification of useful information useful for the user to the user.

12. A parking lot management method, using a computer, comprising:
receiving designation of an exit reservation time at which a vehicle will exit a parking lot; and
confirming presence or absence of designation of the exit reservation time for a vehicle intended to be parked in the parking lot,
wherein
receiving the designation of the exit reservation time comprises receiving the designation of the exit reservation time in a case where an unreserved vehicle for which it is confirmed that the exit reservation time has not been designated is in congestion which occurs in front of an alighting place where a user alights from a vehicle to be parked in the parking lot.

13. A computer-readable non-transitory storage medium storing a program causing a computer to:
receive designation of an exit reservation time at which a vehicle will exit a parking lot; and
confirm presence or absence of designation of the exit reservation time for a vehicle intended to be parked in the parking lot,
wherein
receiving the designation of the exit reservation time comprises receiving the designation of the exit reservation time in a case where an unreserved vehicle for which it is confirmed that the exit reservation time has not been designated is in congestion which occurs in front of an alighting place where a user alights from a vehicle to be parked in the parking lot.
